(19) United States
(12) Patent Application Publication
(10) Pub. No.: US 2018/0375708 A1
(43) Pub. Date: Dec. 27, 2018

(54) MAPPING BITS IN A COMMUNICATION SYSTEM

(71) Applicant: NOKIA SOLUTIONS AND NETWORKS OY, Espoo (FI)

(72) Inventors: Gilberto BERARDINELLI, Aalborg (DK); Frank FREDERIKSEN, Klarup (DK); Klaus Ingemann PEDERSEN, Aalborg (DK); Preben Elgaard MOGENSEN, Gistrup (DK)

(21) Appl. No.: 15/742,868

(22) PCT Filed: Jul. 13, 2015
(86) PCT No.: PCT/EP2015/065924

§ 371 Date: Jan. 8, 2018

(51) Int. Cl. H04L 27/26; H04L 5/00

(52) U.S. Cl. CPC H04L 27/2636; H04L 5/0007; H04L 5/0042; H04L 27/2605; H04L 5/0044

(57) ABSTRACT

Methods and apparatuses for Orthogonal Frequency Division Multiplexing (OFDM) based communication are disclosed. In a method at least some least important bits derived from data to be transmitted are mapped into at least one portion of an OFDM transmission unit, the at least one portion being reserved for the least important bits. More important bits derived from said data are mapped into a different portion of the ODFM transmission unit.

This disclosure relates to communication of data and more particularly to mapping information and signaling bits into signals transmitted between devices.

A communication system can be seen as any facility that enables communication between two or more devices, for example fixed or mobile communication devices, access points such as base stations and similar nodes, servers, machine-type devices and so on. A communication system and compatible communicating entities typically operate in accordance with a given standard or specification which sets out what the various entities associated with the system are permitted to do and how that should be achieved. For example, standards, specifications and related protocols can define the manner how communications between communication devices and the access points shall be arranged, how various aspects of the communications shall be provided and how the equipment shall be configured.

Signals can be carried on fixed line or wireless carriers. Examples of wireless systems include public land mobile networks (PLMN) such as cellular networks, satellite based communication systems and different wireless local networks, for example wireless local area networks (WLAN). A base station can provide one or more cells, there being various different types of base stations and cells. Wireless communications can also be arranged directly between mobile devices. A user can access the communication system and communicate with other users by means of an appropriate communication device or terminal. Communication apparatus of a user is often referred to as a user equipment (UE). Typically a communication device is used for enabling receiving and transmission of communications such as speech and data. A communication device is provided with an appropriate signal receiving and transmitting arrangement for enabling communications.

Communication of signals between devices can be modulated based on an appropriate modulation technique. Orthogonal Frequency Division Multiplexing (OFDM) is an example of appropriate modulation techniques. OFDM is considered a cost-effective solution for coping with large delay spread channels, and has been adopted by several radio standards, for example IEEE 802.11, Long Term Evolution (LTE) and Long Term Evolution—Advanced (LTE-A). The attractiveness of OFDM is mainly due to its capability of converting a frequency selective channel to multiple flat channels, enabling simple one-tap equalization at the receiver. Discrete Fourier Transform spread OFDM (DFT-s-OFDM) is an add-on over OFDM allowing emulation of a single carrier modulation with advantage in terms of power efficiency.

The effectiveness of both OFDM and DFT-s-OFDM in mitigating fading is made possible through insertion of a Cyclic Prefix (CP) at the beginning of each time symbol, the CP being obtained as a copy of the last part of the symbol itself. If the CP length is such that it is larger than the delay spread of the channel, inter-symbol interference (ISI) can be avoided, and the signal can be seen as cyclic at the receiver. Thus, in the frequency domain the subcarriers where the data symbols are mapped are still orthogonal and efficient frequency domain processing can be applied.

However, use of the CP in an OFDM-based radio standard can lead to limitations in the system design. The CP length must be hard-coded in order to fit with the frame duration. This is typically set according to upper layer requirements (e.g., latency). For instance, in LTE two different subframe structures have been defined: short CP of 4.7 μs with 14 time symbols and long CP of 8.6 μs with 12 time symbols, both fitting the constraint of 1 ms subframe duration. This may lead to unnecessary throughput limitations in case the effective delay spread is significantly lower than the CP duration, as the fixed length can be way too conservative. On the other extreme, the fixed CP length may affect the block error rate (BLER) performance in case the length is not sufficiently long to cope with a large delay spread.

Use of an adaptive CP, where its length is set with fine granularity according to the estimated channel, is unfeasible in practical scheduled systems due to the constraint on the fixed frame duration. Moreover, the usage of different numerologies (e.g., LTE with long CP and short CP) may strongly affect the performance of different networks operating in proximity, since they would generate mutual asynchronous interference which cannot be canceled by receiver without making them computationally unfeasible.

It is noted that the above discussed issues are not limited to any particular communication environment and station apparatus but may occur in any system with OFDM modulation capability.

Embodiments of the invention aim to address one or several of the above issues. In particular, solutions that can be used instead of the CP and provide more flexibility in use of resources might be desired.

According to an aspect there is provided a method for Orthogonal Frequency Division Multiplexing (OFDM) based communication, the method comprising mapping at least some least important bits derived from data to be transmitted into at least one portion of an OFDM transmission unit, the at least one portion being reserved for the least important bits, and mapping more important bits derived from said data into a different portion of the ODFM transmission unit.

According to an aspect there is provided a method for reception of Orthogonal Frequency Division Multiplexing (OFDM) based communication, the method comprising receiving an OFDM transmission unit comprising at least one portion reserved for least important bits derived from data to be transmitted and a different portion comprising more important bits derived from said data, demapping least important bits from the at least one portion of the OFDM transmission unit, and demapping more important bits derived from the different portion of the ODFM transmission unit.

According to an aspect there is provided apparatus configured for Orthogonal Frequency Division Multiplexing (OFDM) based communications, the apparatus comprising a bit mapper configured to map at least some least important bits derived from data to be transmitted into at least one portion of an OFDM transmission unit, the at least one portion being reserved for the least important bits, and more important bits derived from said data into a different portion of the ODFM transmission unit.

According to yet another aspect there is provided apparatus configured for reception of Orthogonal Frequency Division Multiplexing (OFDM) based communications, the apparatus comprising a receiver of an OFDM transmission unit comprising at least one portion reserved for least important bits derived from data to be transmitted and a different portion comprising more important bits derived from said data, and a demapper configured to demap least important bits from the at least one portion of the OFDM transmission unit and more important bits derived from the different portion of the ODFM transmission unit.

In accordance with a more detailed aspect the least important bits comprise parity bits derived from said data to be transmitted. The more important bits may comprise systematic bits.

In accordance with a possibility the transmission unit comprises a guaranteed portion predefined for carrying the most important bits, and at least one of a tail portion and a head portion predefined for carrying at least some of the least important bits. The at least one portion reserved for least important bits may comprise at least one of a low power portion, almost zero power portion and a zero power portion. The size of at least one of the portions may be adjusted according to the current channel conditions.

Information may be included in the OFDM transmission unit regarding the size of the at least one portion of the OFDM transmission unit that has been reserved for the least important bits.

The transmission unit may comprise a Discrete Fourier Transform spread

Orthogonal Frequency Division Multiplex (DFT-s-OFDM) symbol. Zero-tail Discrete Fourier Transform spread Orthogonal Frequency Division Multiplex (ZT DFT-s-OFDM) modulation of bits may be provided.

At least one of the least important bits may be muted when resource is required for transmission of more important bits. Modulation and coding scheme may be adjusted according to a potential loss caused by the muting of one or more of the least important bits.A computer program comprising program code means adapted to perform the herein described methods may also be provided. In accordance with further embodiments apparatus and/or computer program product that can be embodied on a computer readable medium for providing at least one of the above methods is provided.

A node such as an access point, a base station, a mobile station, a controller for an access system or a controller for core network may be configured to operate in accordance with at least some of the embodiments. A communications device adapted for the operation can also be provided. A communication system embodying the apparatus and principles of the invention may also be provided.

It should be appreciated that any feature of any aspect may be combined with any other feature of any other aspect.

Embodiments will now be described in further detail, by way of example only, with reference to the following examples and accompanying drawings, in which:

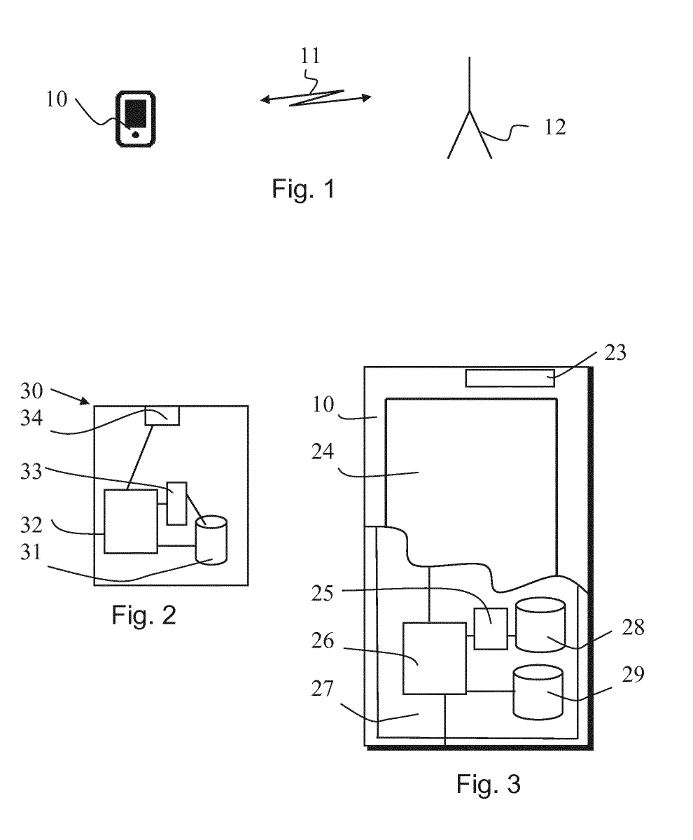

FIG. 1 shows a schematic diagram of a wireless system where certain embodiments can be implemented;

FIG. 2 shows a schematic diagram of a control apparatus according to some embodiments;

FIG. 3 shows a schematic presentation of a possible communication device;

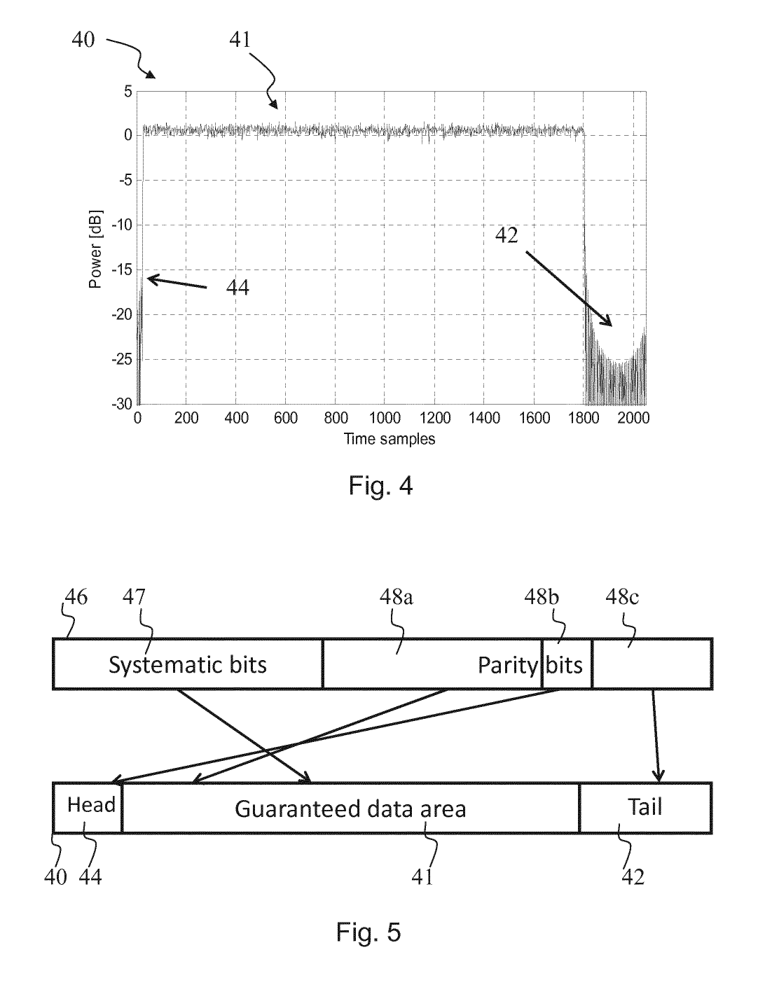

FIG. 4 shows an example of an OFDM signal;

FIG. 5 shows an example of mapping bits from a data transfer block to a signal;

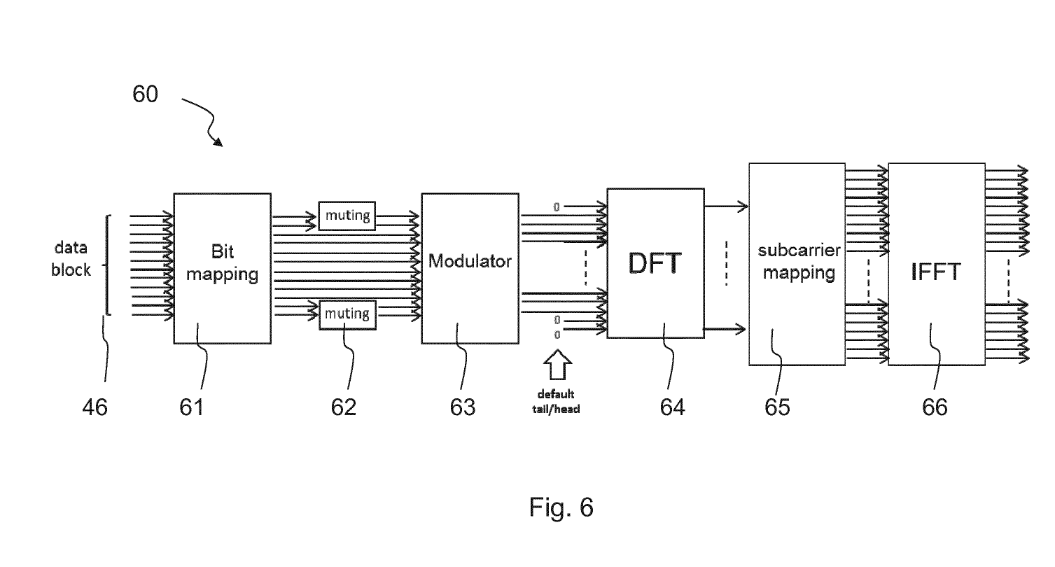

FIG. 6 shows an example of mapping and muting in accordance with an embodiment; and

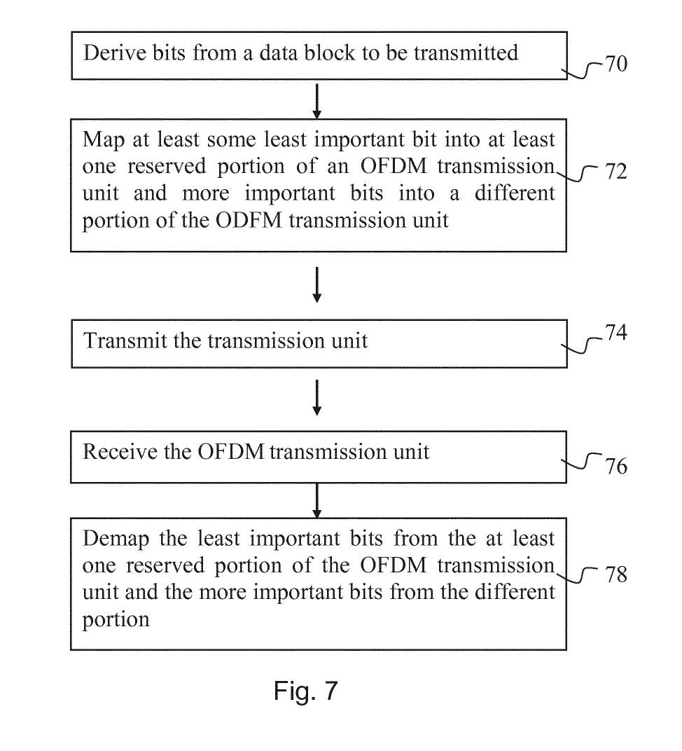

FIG. 7 is a flowchart according to an example.

In the following certain exemplifying embodiments are explained with reference to communication devices capable of wireless communications. Before explaining in detail the exemplifying embodiments, certain general principles of a wireless communications, wireless access and mobile communication devices are briefly explained with reference to FIGS. 1 to 3 to assist in understanding the technology underlying the described examples.

FIG. 1 shows schematically two devices, name a mobile device 10 and a base station 12 communicating over a wireless link 11. A non-limiting example of possible wireless communication system architectures is the long-term evolution (LTE) of the Universal Mobile Telecommunications System (UMTS) that is being standardized by the 3rd Generation Partnership Project (3GPP). The current standardization of 3GPP is already aiming for the future 5th generation (5G) cellular systems. Other examples of radio system include those provided based on technologies such as wireless local area network (WLAN) and/or WiMax (Worldwide Interoperability for Microwave Access).

In wireless systems a communication device or terminal can be provided wireless access via one or more base stations (e.g. eNBs) or similar wireless transmitter and/or receiver nodes adapted to provide access points of a radio access system.

Communication devices such as mobile devices and access points, and hence communications are typically controlled by at least one appropriate controller apparatus so as to enable operation thereof and management of communications between the devices. FIG. 2 shows an example of a control apparatus for a node, for example to be integrated with, coupled to and/or otherwise for controlling an access point, such as the base station 12 of FIG. 1. The control apparatus 30 can be arranged to provide control on communications by the relevant device. For this purpose the control apparatus comprises at least one memory 31, at least one data processing unit 32, 33 and an input/output interface 34. Via the interface the control apparatus can be coupled to relevant other components of the device. The control apparatus can be configured to execute an appropriate software code to provide the control functions. It shall be appreciated that similar components can be provided in a control apparatus provided elsewhere in the network system, for example in a core network entity. The control apparatus can be interconnected with other control entities. The control apparatus and functions may be distributed between several control units. For example, each base station can comprise a control apparatus whereas in alternative embodiments two or more base stations may share a control apparatus.

The communication device 10 may comprise any suitable device capable of at least receiving wireless communication of data. For example, the device can be handheld data processing device equipped with radio receiver, data processing and user interface apparatus. Non-limiting examples include a mobile station (MS) such as a mobile phone or what is known as a ‘smart phone’, a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, ear pieces with wireless connectivity, jewelry and so on, universal serial bus (USB) sticks with wireless capabilities, modem data cards, machine type devices or any combinations of these or the like.

FIG. 3 shows a schematic, partially sectioned view of a possible communication device. More particularly, a handheld or otherwise mobile communication device 10 is shown. The mobile communication device is provided with wireless communication capabilities and appropriate electronic control apparatus for enabling operation thereof. Thus the mobile device 10 is shown being provided with at least one data processing entity 26, for example a central processing unit and/or a core processor, at least one memory 28 and other possible components such as additional processors 25 and memories 29 for use in software and hardware aided execution of tasks it is designed to perform. The data processing, storage and other relevant control apparatus can be provided on an appropriate circuit board 27 and/or in chipsets. Data processing and memory functions provided by the control apparatus of the mobile device are configured to cause control and signaling operations in accordance with certain embodiments of the present invention as described later in this description. For example, a processor and a memory can be configured for storing and/or processing of information relating to the signals communicated before, during and/or after the communications. A user may control the operation of the mobile device by means of a suitable user interface such as touch sensitive display screen or pad 24 and/or a key pad, one of more actuator buttons 22, voice commands, combinations of these or the like. A speaker and a microphone are also typically provided. Furthermore, a mobile communication device may comprise appropriate connectors (either wired or wireless) to other devices and/or for connecting external accessories, for example hands-free equipment, thereto.

The mobile device may communicate wirelessly via appropriate apparatus for receiving and transmitting signals. FIG. 3 shows schematically a radio block 23 connected to the control apparatus of the device. The radio block can comprise a radio part and associated antenna arrangement. The antenna arrangement may be arranged internally or externally to the mobile device. The antenna arrangement may comprise elements capable of beamforming operations. Beamforming may be provided for transmitting, receiving or both.

The following discloses in detail certain examples of use of different portions of an OFDM transmission unit for communication of different bits in wireless systems, for example 5^{th} generation (5G) wireless systems. In accordance with a detailed example an OFDM transmission unit with predefined portions reserved for different bit may be provided in a form of a Discrete Fourier Transform spread Orthogonal Frequency Division Multiplexing (DFT-s-OFDM) symbol or signal as shown in FIG. 4.

Examples described below relate to bit mapping for improving robustness of data transfer when using so called zero-tail Discrete Fourier Transform spread Orthogonal Frequency Division Multiplexing (ZT DFT-s-OFDM) modulation. ZT DFT-s-OFDM can be seen as a modified version of DFT-s-OFDM modulation, a difference being that the Cyclic Prefix (CP) of the OFDM is replaced with a low power, or even nearly zero-power, tail. The tail is a part of the Inverse Fast Fourier Transform (IFFT) output. This is advantageous, for example, in Long Term Evolution (LTE) based systems where the size of the Cyclic Prefix (CP) has traditionally been static, and there has been only two sizes available (long and short) from which to select one static CP for use. In zero tail (ZT) DFT-s-OFDM the static cyclic prefix can be replaced with a dynamically sized tail. Thus there is no need to add the fixed CP in front of the symbols before transmission but instead control bits (typically zeroes) can be derived from information in the transport block before modulation thereof. Thus only information that relates to data received for transmission needs to be mapped and there is no need for addition of the fixed CP. Instead, an adjustable tail part and/or head part of an OFDM transmission unit, for example a DFT-s-OFDM symbol, can be provided.

Because of the tail part of a signal and the possibility of dynamically sizing the tail, the ZT DFT-s-OFDM provides various attractive properties. For example, ZT DFT-s-OFDM can allow adaptation of the overhead to cope with the delay spread of the radio channel to the estimated instantaneous channel conditions, rather than relying on a potentially inefficient hard-coded Cyclic Prefix (CP). The ZT DFT-s-OFDM can also be used to decouple physical layer radio numerology from radio channel characteristics. This allows cells of different sizes, receiving devices at different distances from the transmitter, and/or operating over channel having different characteristics, to adopt the same numerology (e.g., number of symbols per frame). Use of zero tail can also improve the spectral containment with respect to baseline OFDM/DFT-s-OFDM. Lower peak-to-average Power ration (PAPR) than OFDM may also be provided. The PAPR achieved can be similar to what is achievable by DFT-s-OFDM.

A snapshot of the transmit power versus time of an exemplifying ZT DFT-s-OFDM signal is shown in FIG. 4. The shown signal pattern 40 features a low power tail 42 and a short low power head 44 and a central region 41 between the low power areas 42 and 44. While the low power tail 42 is intended to cope with a measured delay spread of the relevant channel, the low power head 44 can be inserted in the transmission unit in order to avoid power regrowth at the last samples of the tail due to the cyclical nature of the IFFT operation.

The different portions can be reserved for carrying different types of bits. At least one of the portions 42 and 44 can be especially reserved for a predefined class of bits. Bits to be mapped into a symbol can have different levels of importance and a portion or portions can be reserved accordingly. E.g. bits known as systematic bits can be classed to be the most important bits and mapped into the central region but not in the head or tail forming the edges of the transmission unit. Bits such as parity bits in turn can be classed as the least important bits. Such bits of lesser importance can be mapped into the tail and/or head portions of transmission unit 40. A transport block can thus comprise bits with different levels of importance, e.g., systematic and parity bits, mapped in different parts of a transmission unit depending on the importance.

The herein disclosed bit mapping technique can be used to ensure that the least valuable bits to be transmitted are mapped to the more vulnerable tail part of the transmitted ZT DFT-s-OFDM signal of FIG. 4 whereas the important bits are mapped to the more robust central region. An example of such mapping is shown in FIG. 5 where bits from a transport data block 46 are mapped to a transmission unit 40.

More particularly, FIG. 5 shows three sets 48a, 48b and 48c of least important bits, for example parity bits, in the transport block 46. The arrows between blocks 46 and 40 show how the least important bits of the transport block 46 can be mapped to the low power tail 42 and/or head 44 of the signal block 40. The parity bits can also be mapped elsewhere in the signal block 40. Such bits can nevertheless be punctured to make space, e.g., for a dynamic tail at the end of the timeslot. The least important bits, e.g., parity bits 48c, can be mapped specifically to the low power tail 42 reserved for this purpose so that any residual inter-symbol interference (ISI), e.g. interference caused by a delay spread that is larger than an estimated delay spread, would only impact the least important bits.

As also shown by FIG. 5, mapping of at least some of the least important bits 48b of a transport block 46 can also take place into the head part 44 of the transmission unit 40. Bits in this part of the symbol may suffer from interference of a delayed preceding symbol, especially if received by a device far away from the transmitting station. However, by defining that that the bits in such portion are “only” parity bits considered to be of lesser importance, the overall operation should not be affected significantly.

The more valuable bits, for example the systematic bits 47, can be mapped to the “safe” central region 41 of the ZT DFT-s-OFDM signal. This is advantageous since the central region is not easily affected by leakage due to self-interference from previous symbols or time multiplexed devices such as mobile user equipment (UE).

Further, excess parity bits that do not fit into the tail 42 and head 44 can be mapped to the central region 41. Thus the central region can be “filled” with the predefined least important bits, e.g. parity bits, if needed. The least important bits are preferably mapped in the front edge of the central region 41 so that if they cause any interference due to delay and/or incorrect sizing of the portions, this would most likely only affect the tail portion of the preceding symbol.

Thus the least important bits can be mapped at the edge regions of the symbols where their potential to cause interference to adjacent symbols can be less. Also, because this information is of lesser importance loss thereof e.g. because of interference from adjacent symbols can be tolerated.

A software code implementing a bit mapping algorithm for the physical channel mapping can be provided at the transmitting device. FIG. 6 shows a transmitter 60 where the code can be executed in a bit mapping part 61 to ensure that the least valuable bits e.g. from the forward error correction (FEC) process, typically the parity bits, are mapped to the low power tail regions of the transmitted signal reserved for this purpose.

Reserved portions for an DFT-s-OFDM symbol or another transmission unit for OFDM based communications can be defined beforehand e.g. in a relevant standard and/or protocol so that e.g. a base station and a mobile station (eNB and UE) can have the same understanding of the different regions based on a common definition thereof. The common definition can thus be reached through standard specifications. An eNB signalling approach or implicit signalling, for instance by coupling the definition to bandwidth, Transmit Time Interval (TTI) duration, etc., may also be provided.

The reserved portions can be defined such that the transmit device “directs” the systematic and parity bits into the relevant portions, and the receiving device knows where it can expect to receive the particular bits.

In addition, it is possible have an algorithm in the transmitting device (e.g. a base station) that “prunes” some of the bits from one of the defined reserved regions (the tail region as one example). Since the parity bits have been “directed” to this region already, the impact to the received (e.g. UE) decoding is minimized, as these bits are less important than the systematic bits. The “pruning” of bits can be dependent on various conditions, and can be specific to the conditions that each receiving device is experiencing.

In accordance with a possibility tail parts of signal blocks can be dynamically adjusted to provide optimum resource utilization of the radio resources. This enables more efficient use of the physical resources to the limits given by the physical propagation channel. The dynamic adjustment can be used to allow for adapting the applied overhead for data protection to the radio channel conditions. The tail can be set, for example, according to the delay spread of the channel in order to avoid energy leakage on the next time symbols (inter-symbol interference). It is also possible to adjust the head of the signal, especially to extend it to avoiding interference coming from time multiplexed UEs experiencing different delay spreads.

The herein disclosed mapping approach allows for a transmitter unit to flexibly adjust the size of the head and/or tail “on the fly” according to the current channel conditions without additional signalling and without significantly penalizing the performance. When doing so the transmitter unit may mute some of the parity bits. However, as these bits are least important in terms of the decoding process in the receiver end, this does should not significantly affect the quality of the communications. An example of muting by the bit mapping part 61 before modulation stage 63 is also shown in FIG. 6.

According to a possibility a transmitter unit can assume a default value for the head and the tail of the signal, and decide the transport block size accordingly. In case a larger tail/head is suddenly needed, the transmitter can mute some of the resources at the edge(s) of the block. Muting of at least one of the edges of the data block 46 is illustrated by blocks 62 in FIG. 6.

During the transmission process, the transmit node is free to mute (i.e. zero) some of the head and/or tail bits in order to maintain protection of the transmitted data towards inter-symbol interference between transmitted data symbols. The purpose of the tail can also be partly controlled by the head part.

After modulation at 63, the modulated signal with low power parts is input in a discrete fourier transform block 54, and therefrom to a subcarrier mapping block 65. Inverse fast fourier transform is then performed on the signal at block 66.

The embodiments can be implemented as a mapping arrangement defined for transmitter and the receiver devices. The demapping at the receiver can be provided in accordance with the same but reversed procedure to the mapping at the transmitter.

The arrangement can be such that it is possible for a receiving device, for example a user equipment (UE), to make blind estimation of the size of the zero head and/or tail in order to assist decoding procedure. A blind detection mechanism can thus be provided at the receiver end for detection of the actual size of the tail part and/or head part. However, in many applications the blind detection may be of lesser importance as the channel decoding will most likely have similar performance compared to the full decoding of the entire packet, as the estimation of the soft values for the channel decoding would assign low likelihood values to the zeroed data symbols.

Additionally, it can be made possible for the transmitter to adjust its selection of modulation and coding scheme according to the potential loss incurred on the physical link by doing automatic muting in the zero head and tail areas.

FIG. 7 shows a flowchart for operation at a transmitter prior to transmission of the signal at step 74 and at a receiver after the step of receiving the signal. More particularly, at the transmitter a method for Orthogonal Frequency Division Multiplexing (OFDM) based communication comprises deriving bits from a transport data block at 70 for mapping into an OFDM transmission unit for OFDM based communication. In the method at least some least important bits that have been derived from the data to be transmitted are mapped at 72 into at least one portion of an OFDM transmission unit, the at least one portion being reserved for the least important bits, while more important bits derived from said data are mapped into a different portion of the ODFM transmission unit.

The OFDM transmission unit can then be transmitted at 74.

At the receiver the method for reception of the Orthogonal Frequency Division Multiplexing (OFDM) based communication comprises receiving, at 76, an OFDM transmission unit and subsequent demapping the least important bits and more important bits. More particularly, in a method for reception of Orthogonal Frequency Division Multiplexing (OFDM) based communication, an OFDM transmission unit comprising at least one portion reserved for least important bits derived from data to be transmitted and a different portion comprising more important bits derived from said data is received at 76. At 78 least important bits are demapped from the at least one reserved portion of the OFDM transmission unit and said more important bits are demapped from the different portion.

The herein described transmission unit can be defined to have separate parts reserved for different classes of bits derived from the data to be transmitted. The transmission unit may comprise a potential head, a definite signal carrying part, and a potential tail. The mapping of bit into the parts can be dynamic. The herein proposed concept allows for the tail to be dynamically adjusted, and hence the bit mapping scheme allows for adjustment to automatically cut the least important parts of the coded user signal. For example, if a tail is incorrectly sized (e.g. because a receiving devise is further away than anticipated, and/or the delay is longer than the tail for another reason), the bits affected would be only the least important bits. In accordance with a possibility the mapping scheme can be arranged according to a preset rules that take into account resource allocation, coding rate, and possibly other relevant information. The scheme can be adapted to dynamically adjust the size of the tail portion during the transmission operation. A benefit from this would be that the receiving device, for example a UE, can use a general scheme for demodulation and decoding. This in turn can mean that there is no need to indicate any significant amounts of information on how much of the tail the eNB side decides to transmit. The size of the tail can depend on the instantaneous channel conditions, and may need to be altered very rapidly, without a realistic possibility of signaling information thereof to the other party.

The required data processing apparatus and functions to provide the herein described methods e.g. at network elements such as base station apparatus and other access points and controller elements, a communication device, and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1. A method for Orthogonal Frequency Division Multiplexing (OFDM) based communication, the method comprising:
mapping at least some least important bits derived from data to be transmitted into at least one portion of an OFDM transmission unit, the at least one portion being reserved for the least important bits, and
mapping more important bits derived from said data into a different portion of the ODFM transmission unit.

2. A method for reception of Orthogonal Frequency Division Multiplexing (OFDM) based communication, the method comprising:
receiving an OFDM transmission unit comprising at least one portion reserved for least important bits derived from data to be transmitted and a different portion comprising more important bits derived from said data,
demapping least important bits from the at least one portion of the OFDM transmission unit, and
demapping more important bits derived from the different portion of the ODFM transmission unit.

3. A method according to claim 1, wherein the least important bits comprise parity bits derived from said data to be transmitted and/or the more important bits comprise systematic bits.

4. A method according to claim 1, wherein the transmission unit comprises a guaranteed portion predefined for carrying the most important bits, and at least one of a tail portion and a head portion predefined for carrying at least some of the least important bits.

5. A method according to claim 1, wherein the at least one portion reserved for least important bits comprises at least one of a low power portion, almost zero power portion and a zero power portion.

6. A method according to claim 5, comprising adjusting the size of at least one of the portions according to the current channel conditions.

7. A method according to claim 1, comprising:
including information in the OFDM transmission unit regarding the size of the at least one portion of the OFDM transmission unit that has been reserved for the least important bits.

8. A method according to claim 1, comprising:
muting at least one of the least important bits when resource is required for transmission of more important bits.

9. A method according to claim 8, comprising:
adjusting modulation and coding scheme according to a potential loss caused by the muting of one or more of the least important bits.

10. A method according to claim 1, wherein the transmission unit comprises a Discrete Fourier Transform spread Orthogonal Frequency Division Multiplex (DFT-s-OFDM) symbol.

11. A method according to claim 10, comprising zero-tail Discrete Fourier Transform spread Orthogonal Frequency Division Multiplex (ZT DFT-s-OFDM) modulation of bits.

12. An apparatus configured for Orthogonal Frequency Division Multiplexing (OFDM) based communications, the apparatus comprising:
a bit mapper configured to map at least some least important bits derived from data to be transmitted into at least one portion of an OFDM transmission unit, the at least one portion being reserved for the least important bits, and more important bits derived from said data into a different portion of the ODFM transmission unit.

13. An apparatus configured for reception of Orthogonal Frequency Division Multiplexing (OFDM) based communications, the apparatus comprising:
a receiver of an OFDM transmission unit comprising at least one portion reserved for least important bits derived from data to be transmitted and a different portion comprising more important bits derived from said data, and
a demapper configured to demap least important bits from the at least one portion of the OFDM transmission unit and more important bits derived from the different portion of the ODFM transmission unit.

14. An apparatus according to claim 13, wherein the least important bits comprise parity bits derived from said data to be transmitted and/or the more important bits comprise systematic bits.

15. An apparatus according to claim 13, wherein the transmission unit comprises a guaranteed portion predefined for carrying the most important bits and at least one of a tail portion and a head portion predefined for carrying at least some of the least important bits.

16. An apparatus according to claim 13, wherein the at least one portion reserved for least important bits comprises at least one of a low power portion, almost zero power portion and a zero power portion.

17. An apparatus according to claim 16, wherein the apparatus is configured for adjustment of the size of at least one of the portions according to the current channel conditions.

18. An apparatus according to claim 13, configured to include information in or read information from the OFDM transmission unit regarding the size of the at least one portion of the OFDM transmission unit that has been reserved for the least important bits.

19. An apparatus according to claim 13, configured to process muting of at least one of the least important bits when resource is required for transmission of more important bits.

20. An apparatus according to claim 19, configured to adjust modulation and coding scheme according to a potential loss caused by the muting of one or more of the least important bits.

21. A device for wireless communications comprising the apparatus according to claim 13.

22. A computer program comprising program code adapted to perform the steps of claim 1 when the program code is run on a processor.

23. A computer program comprising program code adapted to perform the steps of claim 2 when the program code is run on a processor.

24. A method according to claim 2, wherein the least important bits comprise parity bits derived from said data to be transmitted and/or the more important bits comprise systematic bits.

25. A method according to claim 2, wherein the transmission unit comprises a guaranteed portion predefined for carrying the most important bits, and at least one of a tail portion and a head portion predefined for carrying at least some of the least important bits.

26. A method according to claim 2, wherein the at least one portion reserved for least important bits comprises at least one of a low power portion, an almost zero power portion and a zero power portion.

27. A method according to claim 2, comprising:
including information in the OFDM transmission unit regarding the size of the at least one portion of the OFDM transmission unit that has been reserved for the least important bits.

28. A method according to claim 2, comprising:
muting at least one of the least important bits when resource is required for transmission of more important bits.

29. An apparatus according to claim 12, wherein the least important bits comprise parity bits derived from said data to be transmitted and/or the more important bits comprise systematic bits.

30. An apparatus according to claim 12, wherein the transmission unit comprises a guaranteed portion predefined for carrying the most important bits and at least one of a tail portion and a head portion predefined for carrying at least some of the least important bits.

31. An apparatus according to claim 12, wherein the at least one portion reserved for least important bits comprises at least one of a low power portion, almost zero power portion and a zero power portion.

32. An apparatus according to claim 12, configured to include information in or read information from the OFDM transmission unit regarding the size of the at least one portion of the OFDM transmission unit that has been reserved for the least important bits.

33. An apparatus according to claim 12, configured to process muting of at least one of the least important bits when resource is required for transmission of more important bits.
